(19) United States
(12) Patent Application Publication
(10) Pub. No.: US 2017/0278151 A1
(43) Pub. Date: Sep. 28, 2017

(54) Systems And Methods for Creating An Online Educational And Career Marketplace

(71) Applicant: Adeboyejo Adetokunbo Oni, Bethesda, MD (US)

(72) Inventor: Adeboyejo Adetokunbo Oni, Bethesda, MD (US)

(21) Appl. No.: 15/081,290

(22) Filed: Mar. 25, 2016

(51) Int. Cl. G06Q 30/06

(52) U.S. Cl. CPC G06Q 30/0601; G06Q 50/205

(57) ABSTRACT

An online marketplace for individuals applying to academic institutions, employers, internship and apprenticeship programs or to trade or vocation programs is provided. The marketplace is formed using an inventive platform and user devices that exchange information. The information exchanged is used to market the user's academic, life skills and experiences to institutions, employers and other entities that must, thereafter, compete with one another in order to convince the individual to accept admission to an institution or accept a position of employment.

### RELATED APPLICATIONS

This application is related to U.S. patent application Ser. No. 14/883,424 (the “'424 application”) filed Oct. 14, 2015 and U.S. patent application Ser. No. 10/657,562 (the “'562 application”) now U.S. Pat. No. 7,299,217 and incorporates by reference herein the entire disclosures, both text and drawings, of the '424 and '562 applications as if set forth in full herein.

### INTRODUCTION

Historically, in some countries the process of applying to an institution of higher learning, such as a university or college, is a daunting challenge. Not only must the individual identify and select those institutions the individual seeks to apply to, the individual must complete an application process for each selected institution, and once admitted to an institution, the individual must retain a number of third party service providers to assist the individual in actually attending the institution. For example, an admitted individual must identify and secure: (i) financial aid from the institution; (ii) housing located at, or nearby, the institution; (iii) banking and other financial services from a third party service provider (e.g., a bank) nearby the institution; (iv) transportation of the individual's personal belongings to, and from, the institution sometimes using a third party service provider; (v) educational material, such as books, and electronic devices; (vi) work at, or nearby, the institution to help the individual pay for the institution's tuition and housing; (vii) work as an apprentice or intern in the individual's desired career path; and (viii) tutoring and academic counseling to assist the individual complete his or her courses and chart a path towards an academic or career goal. Accordingly, the individual needs many services.

To date, the process of identifying, applying and securing acceptance into an institution of higher learning as well as identifying and securing the types of services and financial aid described above has been “tilted” in favor of the institution, service provider or source of financial aid. For example, many institutions of higher learning receive thousands, if not tens of thousands, of applications each year from individuals seeking to gain admission to such an institution. From these applications, an institution may only be able to grant admission to a fraction of the overall individuals that apply. For example, a given institution may only be able to grant admissions to ⅓ or ¼ of the students that apply. Because there are so many students that apply compared to the number that are actually admitted the admission process is “tilted” in favor of the institutions.

Accordingly, it is desirable to provide systems and methods for “leveling the playing field” for individuals applying to institutions and requiring services, that is, providing such individuals with the ability to market their academic and other achievements to institutions and have such institutions compete to entice the individual to apply to, and accept admission to, to their institution as well as providing such individuals with options when it comes to selecting service providers.

It is further desirable to provide similar systems and methods for leveling the playing field for individuals seeking (i) the assistance of service providers, (ii) employment, (iii) financial aid, or (iv) access to training and apprenticeships, for example.

Still further, it is desirable to provide systems and methods for broadening the marketplace (e.g., number of people) to which individuals (e.g., students) can provide their credentials (e.g., accomplishments, skills and capabilities) in order to increase the probability that the individuals will achieve better success in obtaining an acceptable offer

### SUMMARY

In accordance with the present invention, embodiments of inventive systems provide services, benefits and privileges to individuals and entities that participate in an educational and career marketplace. One such system comprises a network hardware platform operable to (i) receive information identifying an offeree, the offeree's credentials and one or more primary, offeree visibility indicators, and (ii) determine whether to provide the identity of the offeree and the offeree's credentials to a number of offerors based on the one or more primary, offeree visibility indicators.

The number of offerors may be 0, 1 or more than 1, and each offeror may be a member of an academic institution, trade or vocational institution, a trade or vocation, an employer or a resource provider, to name just a few of the many types of offerors.

In one embodiment, the one or more primary, offeree visibility indicators include one or more indicators that indicate whether the offeree's identity and credentials should, or should not, be provided to the number of offerors. One example of credentials may be an offeree's academic record or life experiences.

If the one or more visibility indicators include an indicator that indicates the identity of the offeree should be provided to the number of offerors, then in one embodiment the hardware platform may be operable to so provide the identity of the offeree to a number of offerors. If, on the other hand, the one or more primary, offeree visibility indicators include an indicator that indicates the identity of the offeree should not be provided to the number of offerors, then the hardware platform may be operable to inhibit the provisioning of the identity of the individual to the number of offerors.

In additional embodiments the offeree's credentials may be provided to a number of offerors. For example, if the one or more visibility indicators include an indicator that indicates the credentials should be provided to the number of offerors, then the hardware platform may be operable to provide the credentials to the number of offerors indicated, or otherwise identified by, the visibility indicators. Similarly, if the one or more visibility indicators include an indicator that indicates the credentials should not be provided to a number of offerors, then the hardware platform may be operable to inhibit the provisioning of the credentials to the number of offerors indicated or identified by the visibility indicators.

Embodiments of the invention also receive information from offerors as well as offerees. For example, in one embodiment an exemplary system comprises a hardware platform that is operable to (a) receive information regarding the identity of a number of offerors, each identified offeror's offer and one or more primary, offeror visibility indicators associated with each of the number of offerors, and (b) determine whether to provide the identity of each of the number of offerors and each offeror's offer to an offeree based on the one or more primary, offeror visibility indicators.

The one or more primary, offeror visibility indicators may include one or more indicators that indicate one or more of the offerors' identities should, or should not, be provided to an offeree.

In one embodiment, if one or more of the primary, offeror visibility indicators includes an indicator that indicates the identity of a number of offerors should be provided to an offeree, then the hardware platform may be operable to provide the identity of the number of offerors to the offeree as indicated by the visibility indicators. In contrast, if the one or more primary, offeror visibility indicators includes an indicator that indicates the identity of a number of offerors should not be provided to the offeree, then the hardware platform may be operable to inhibit the provisioning of the identity of a number of offerors to an offeree.

Similarly, the one or more primary, offeror visibility indicators may include an indicator that indicates an offer or offers of one or more of the offerors should be provided to the offeree. If so, then the hardware platform may be operable to provide the indicated offers to the offeree. If not (i.e., the one or more primary, offeror visibility indicators include an indicator that indicates the offers of the number of offerors that should not be provided to the offeree), then the hardware platform may be operable to inhibit the provisioning of the indicated offers to the offeree.

In addition to controlling “when”, and “what” types of, information may be disclosed between offerees and offerors, the present invention also provides for embodiments that control when, and what type of, information may be disclosed between one offeror and another, and between one offeree and another.

For example, in one embodiment a hardware platform maybe operable to (1) receive one or more secondary (instead of primary), offeror visibility indicators associated with each of a number of offerors, and (2) determine whether to provide the identity of one of the number of offerors and the offeror's associated offer to another one of the number of offerors based on the one or more secondary, offeror visibility indicators. The one or more secondary, offeror visibility indicators may include one or more indicators that indicates the identity of one of a number of offerors, and each offeror's associated offer, that should be provided to another offeror (e.g., another one of the number of offerors).

The number of offerors may be 0, 1 or more than 1, and each offeror may be a member of an academic institution, trade or vocational institution, a trade or vocation, an employer or a resource provider, to name just a few of the many types of offerors.

From the discussion above and herein, it should be understood that the secondary, offeror visibility indicators controls the type of information that may disclosed between offerors.

Accordingly, if, indeed, one of the one or more secondary, offeror visibility indicators include an indicator that indicates the identity of one of the number of offerors should be provided to another one of the number of offerors, then the hardware platform may be operable to provide the identity of the indicated offeror to another one of the number of offerors. Conversely, if one of the one or more secondary, offeror visibility indicators include an indicator that indicates the identity of one of the number of offerors, or the offer of one of the number of offerors, should not be provided to another offeror (e.g., another one of the number of offerors), then the hardware platform may be operable to inhibit the provisioning of the identity or offer of the indicated offeror to another one of the number of offerors.

As mentioned above, the secondary, offeror visibility indicators control the type of information that may disclosed between offerors. Accordingly, if one or more of the secondary, offeror visibility indicators include an indicator that indicates the offer of one of the number of offerors should be provided to another one of the number of offerors, then the hardware platform may be operable to provide the indicated offer to another one of the number of offerors. However, if one of the one or more secondary, offeror visibility indicators include an indicator that indicates the offer of one of the number of offerors, and the identity of one of the number of offerors, should not be provided to another one of the number of offerors, then the hardware platform may be operable to inhibit the provisioning of the indicated offer and identity to another one of the number of offerors.

Similar to offerors, the type of information that may disclosed between offerees may be controlled by secondary, offeree visibility indicators. In one embodiment, a hardware platform maybe operable to (i) receive one or more secondary, offeree visibility indicators, an (ii) determine whether to provide the identity of the offeree, the offeree's credentials and an offer received by the offeree to a number of other offerees based on the one or more secondary, offeree visibility indicators. The number of other offerees may be 0, 1 or more than 1.

If, indeed, one or more secondary, offeree visibility indicators include an indicator that indicates the identity of an offeree should be provided to a number of other offerees, then the hardware platform may be operable to provide the identity of the offeree to the number of other offerees. Similarly, if one of the one or more secondary, offeree visibility indicators include an indicator that indicates the credentials of the offeree should be provided to the number of other offerees, then the hardware platform may be operable to provide the offeree's credentials to the number of other offerees.

On the other hand, if one of the one or more secondary, offeree visibility indicators include an indicator that indicates the identity of the offeree, or credentials of the offeree, or the offer received by an offeree should not be provided to the number of other offerees, then the hardware platform may be operable to inhibit the provisioning of the identity, credentials or offer of the offeree to the number of other offerees. Similarly, if one of the one or more secondary, offeree visibility indicators include an indicator that indicates the credentials of the offeree, identity of the offeree and the offer received by the offeree should not be provided to the number of other offerees (e.g., nothing should be provided to another offeree), then the hardware platform may be operable to inhibit the provisioning of the credentials, identity and any offer received by the offeree to the number of other offerees.

In addition to hardware platforms, the present invention also provides user devices. For example, in one embodiment a system provided by the present invention includes both a hardware platform and one or more user devices. In another embodiment, a system comprises just a hardware platform (or platforms), Still in another embodiment, a system comprises user device and no hardware platform.

More particularly, in one embodiment a user device may comprise a wired or wireless, offeree user device operable to transmit information identifying the offeree, the offeree's credentials and the one or more primary, offeree visibility indicators to a network hardware platform, and/or receive an identity of each offeror and each offeror's offer, and/or advice from a consultant. The information transmitted may be transmitted to a hardware platform first and then on to an offeror or consultant, or be transmitted directly to an offeror or consultant.

In another embodiment, a user device may comprise a wired or wireless, offeror user devices operable to receive the identity of an offeree and the offeree's credentials, and transmit information regarding the identity of a user (and/or entity the user represents) of the offeror user device, an offer and one or more primary and secondary, offeror visibility indicators. The information transmitted may be transmitted to a hardware platform first and then on to an offeree, or be transmitted directly to an offeree.

Still further, the invention provides for embodiments that include a wired or wireless, offeree user device that may be operable to receive an identity of each offeror and each offeror's offer, or receive advice from a consultant without first transmitting any information to a hardware platform, or to an offeror or consultant.

Though this summary is intended to summarize the embodiments described herein, it should be understood that variations of the summarized embodiments may be made without departing from the spirit of the invention. For example, other embodiments besides those related to educational or career are covered by the present invention. In general, the teachings of the present invention may be used where one or more individuals or entities desire to withhold their identity from other individuals or entities.

### BRIEF DESCRIPTION OF THE DRAWINGS

FIG. 1 depicts a block diagram of an exemplary system according to one embodiment of the invention.

FIG. 2 depicts another block diagram according to an embodiment of the invention.

FIG. 3 depicts an exemplary “dashboard” in accordance with one or more embodiments of the present invention.

FIGS. 4A, 4B and 4C depict simplified, exemplary flow diagrams of methods according to one or more embodiments of the present invention.

### DETAILED DESCRIPTION, WITH EXAMPLES

Exemplary embodiments of systems and methods for creating an online educational and career marketplace is described herein. It should be understood that, although specific exemplary embodiments are discussed herein, there is no intent to limit the scope of the present invention to such embodiments. To the contrary, it should be understood that the exemplary embodiments discussed herein are for illustrative purposes, and that modified and alternative embodiments may be implemented without departing from the scope of the present invention. Said another way, the exemplary embodiments presented herein are only some of the many that fall within the scope of the present invention, it being practically impossible for the inventors to describe all of the many possible exemplary embodiments and variations that fall within the scope of the present invention.

For example, though the systems and methods described herein focus on applying the inventive systems and methods to educational, career and employment services, it should be understood that this is for illustrative purposes only, it being further understood that the systems and methods may be applied to other types of services such as healthcare, to name just one of the many additional types of services that the inventive systems and methods maybe applied to.

It should be understood that when the description herein describes the use of an “platform” that such a platform may include one or more devices. For example, the devices may comprise one or more hardware servers, as well as one or more processors, memories, caches and databases. The servers and processors may be operable to execute stored, specialized instructions for completing features and functions described herein. Such instructions may be stored in an onboard memory, in separate memory, or in a specialized database for example. Such instructions represent functions and features that have been integrated into memory as stored electronic signals.

It should also be understood that one or more exemplary embodiments may be described as a process or method. Although a process/method may be described as sequential, it should be understood that such a process/method may be performed in parallel, concurrently or simultaneously. In addition, the order of each step within a process/method may be re-arranged. A process/method may be terminated when completed, and may also include additional steps not included in a description of the process/method.

Yet another phrase is “user”. As used herein a user is an individual that exchanges information with systems, devices and platforms provided by the present invention. Exemplary non-limiting examples of a user are an “offeree”, “offeror” and consultant.

The phrase “offeree” means an individual that has received an offer from another individual that represents an entity (an “offeror”), such as an academic institution, for profit or non-profit entity or employer, financial institution, trade or vocational institution, trade or vocational employer, consultant or third party service provider, for example. By “consultant” is meant an individual that provides guidance to the offeree or offeror related to an offer. In the case of an offeree, a consultant may provide many different types of guidance such as preparing an offeree's credentials (e.g., accomplishments, skills and capabilities), how to obtain the best offer from an offeror, how to negotiate an offer, comparison of different offers received by the offeree. By “third party service provider” is meant an individual or entity that provides a service to the individual. A third party service provider may also be an entity, or consultant, and vice-versa. It should be understood that, depending on the context of the description herein, the phrases “offeree”, “offeror” and “consultant” may include a device used by a respective individual that is an offeree, offeror or consultant. Said another way, depending on the context herein the phrases “offeree”, “offeror” and “consultant” may be used as shorthand for the phrases offeree user device, offeror user device or consultant user device, for example.

Some non-limiting examples of an offer are: written or verbal communications from an offeror to an offeree providing the opportunity for the offeree to: (1) attend the entity represented by the offeror, such as a college or university; (2) receive resource assistance (e.g., financial aid, scholarships, grants, loans) from the entity represented by the offeror; (3) become an apprentice or intern of the entity represented by the offeror; or (4) become an employee of the entity represented by the offeror, to name just a few of the many types of offers.

Some non-limiting, specific examples of an offeree are a student applying to, or attending, an institution of higher learning, or an individual applying to, or attending, an internship or apprenticeship for a trade or vocation. Some specific, non-limiting examples of an offeror are an administrator at an institution of higher learning involved in admission decisions, an individual involved in the process of providing financial aid or other resources, or an individual involved in the process of providing employment. A specific, non-limiting example of a consultant is an academic advisor, financial advisor, or mentor, to name just a few of the different types of consultants.

As used herein the terms “disclosed” and “distributed” have synonymous meanings unless the context of the description otherwise dictates different meanings.

As used herein, the term “and/or” includes any and all combinations of one or more of the associated listed items. As used herein, the singular forms “a,” “an” and “the” are intended to include the plural form, unless the context and/or common sense indicates otherwise. It should be further understood that the terms “comprises”, “comprising,”, “includes” and/or “including”, when used herein, specify the presence of stated features, systems, subsystems, steps, operations, elements, and/or components, but do not preclude the presence or addition of one or more other features, systems, subsystems, steps, operations, elements, components, and/or combinations thereof.

It should be understood that, as used herein, the designations “first”, “second”, “third”, etc., is purely to distinguish one component (e.g., app, device, subsystem, section, etc.,) or part of a process from another and does not indicate an importance, priority or status. In fact, the component or parts of a process could be re-designated (i.e., re-numbered) and it would not affect the operation of systems or methods provided by the present invention.

As used herein the phrases “connection”, “connected to”, or similar phrases means an indirect or direct physical connection between at least two different parts of a platform, device or system, or means one part of a platform, device or system is subsumed within (and thereby connected to) at least one other part of a platform, device or system. It should be understood that when one part of a platform, device or system is described or depicted as being connected to another part, other well-known components used to facilitate such a connection may not be described or depicted because such components are well known to those skilled in the art.

Yet further, when one part of a platform, device or system is described or depicted as being connected to another part using “a connection” (or single line in a figure) it should be understood that practically speaking such a connection (line) may comprise (and many times will comprise) more than one physical connection or channel, may be omni-directional or bi-directional, and may or may not include separate data, formatting and signaling.

Still further, it should be understood that a system or device that completes features and functions of embodiments of the invention may include a web browser that is a part of an interface or one or more applications (often referred to herein as an “app” or “apps”) that have been installed into, or downloaded onto, a system or device. An “app” may include “content” (e.g., text, audio and video files), signaling and configuration files. For the sake of convenience and not limitation, the terms “app” or “application” are used herein to refer to any application, but use of such a term also includes a reference to any file or data.

In one embodiment, an app to be downloaded onto a user device may also reside or be stored on one or more hardware devices, such as a server in whole and/or in part, the later indicating that the app may be distributed among, and by, a number of devices (servers). An app may be downloaded to a user device from an app server (or servers as the case may be) or have been otherwise provided and installed on such a server. A given user device may have a need for one or more of the apps installed on a server. Accordingly, it should be understood that each of the embodiments described herein includes protocols, necessary hardware, software and firmware resident on a user device for transmitting and receiving (i.e., “transceiving”) an app, content and/or content identification information relating to the app from/to a server and vice-versa. It should be understood that depending on the content to be transmitted, an app may be installed directly on a user device or may be downloaded from a server by initiating a request to a server to receive a local copy of the app. When a discussion herein describes transmissions from an offeree, offeror or consultant or reception by an offeree, offeror or consultant it should be understood that a web browser and/or app may be used to complete such transmissions and receptions.

It should be noted that the platforms, systems and devices, as well as any subsystems, etc., thereof, illustrated in the figures are not drawn to scale, are not representative of an actual shape or size and are not representative of any actual system, platform or device layout, or manufacture's drawing. Rather, the platforms, systems and devices are drawn so as to help explain the features, functions and processes of exemplary embodiments of the present invention described herein and covered by the claims set forth at the end of this description.

As used herein, the term “embodiment” refers to one example of the present invention.

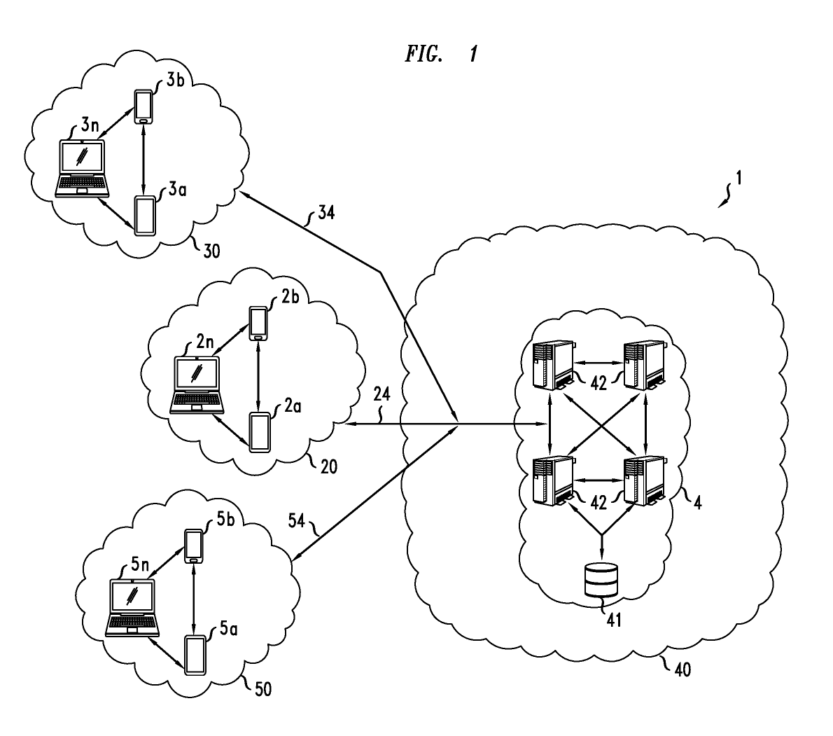

Turning now to FIG. 1, there is depicted a block diagram of an overall system 1 for exchanging information used in an educational and career marketplace according to one embodiment of the invention. As shown in FIG. 1, the system 1 may comprise a network hardware platform 4, offeree user devices 2a, 2b, . . . 2n (where “n” represents the last user device), offeror user devices 3a, 3b, . . . 3n and consultant user devices 5a, 5b, . . . 5n. It should be understood that other components may be included in the system 1, but presently these components and their respective functions are believed to be well known by those skilled in the art, and, therefore, for the sake of clarity their description will be omitted.

Each of the devices 2a, 2b, . . . 2n, 3a, 3b, . . . 3n and 5a, 5b, . . . 5n may be part of a different network or may be part of the same network (e.g., network 20, 30, 50 are the same network), or may be a part of network 40. Each of the devices 2a, 2b, . . . 2n, 3a, 3b, . . . 3n and 5a, 5b, . . . 5n may comprise a wired or wireless device, a desktop computer, a laptop computer, tablet, phablet, hand-held device, terminal, a virtual machine, or server to name just a few examples. Such devices may be located locally or remotely from the platform 4.

In an exemplary embodiment the devices 2a, 2b, . . . 2n, 3a, 3b, . . . 3n and 5a, 5b, . . . 5n may comprise the necessary hardware and software for completing all of the functions and features described herein. For example, hardware for connecting them to the platform 4 and network 40 via wired or wireless means known to those skilled in the art.

It should be understood that a service or services provided by the platform 4 to a user (distinct from services provided by an institution or service provider) may be an “on demand”, real-time service, or, alternatively may comprise a free service, a combination of a free service and a premium service (“freemium” service for short), or still further, may comprise a subscription service. In one embodiment a user of device 2a, 2b, . . . 2n, 3a,3b, . . . 3n or 5a, 5b, . . . 5n may access platform 4 provided the user has been granted access to such free or “freemium” services, or has been granted access to subscription-based services after providing payment (using an app, for example). Platform 4 may comprise a communications hub (not shown in FIG. 1) operable to provide web-based services, and exchange communications with a user of device 2a, 2b, . . . 2n, 3a,3b, . . . 3n or 5a, 5b, . . . 5n in order to grant, or deny, the user access to platform 4 (or specific freemium and subscription functions and features (i.e., services) provided by the platform 4) using one or more authentication and registration processes known in the art. Alternatively, such communications maybe exchanged between a user (user device) and a third party registrar in order to grant, or deny, the user access to specific freemium and subscription functions and features (i.e., services) provided by the platform 4.

The platform 4 and/or devices 2a, 2b, . . . 2n, 3a, 3b, . . . 3n and 5a, 5b, . . . 5n may comprise the necessary hardware and software for completing at least the following functions: tracking a user's status as a paid user (subscriber) or freemium user, tracking the features and services provided by the platform 4 that have been selected by a user as a freemium or paid user, completing e-commerce transactions (e.g., payment for subscription services), providing customer support features (e.g., help desk, technical support, billing inquiries, etc. . . . ), social networking linkage (e.g., to Face book, Twitter, other accounts), those functions required to support communications (e.g., notifications) via one or more apps, and those functions needed to communicate with a third party service provider.

Each device 2a, 2b, . . . 2n, 3a, 3b, . . . 3n and 5a, 5b, . . . 5n may include an interface. Some non-limiting examples of such an interface are a graphical user interface (GUI), web browser, keyboard, touch screen, display, voice recognition system, an interface used by disabled individuals, or some combination of such devices, to name but a few of the many examples of an interface. The interface may be used to exchange communications with the platform 4 or another device via a web browser or an app, for example. Each interface may comprise the necessary electronics (such as one or more processors) specially designed and programmed to complete the features and functions described herein by, for example, accessing integrated instructions stored in memory and/or data stored in memory.

In one embodiment the platform 4 may be a part of a network 40. The network 40 may be a wired or wireless network, such as the Internet, an Intranet, secure network, 3G, 4G, 5G or more advanced network, local area network (LAN), or wide area network (WAN) to name just a few of the many types of networks. Yet another example of platform 4 is a plurality of servers that are part of a cloud-based data center or data centers. Still another example is a plurality of virtual machines stored on a server or computer, for example.

It should be understood that while the overall platform 4 is shown in FIG. 1 as including four servers 42 this is merely exemplary. Alternatively, the platform 4 may be combined into fewer servers or further separated into additional servers. Yet further, the functions completed by each server 42 making up the platform 4 may be distributed, that is, the functions may be separated into individual or grouped functions that are completed by separate servers that may, or may not be, co-located.

Alternatively, platform 4 may comprise one or more processors 42 specially designed and programmed to complete the features and functions described herein by, for example, accessing instructions stored in memory and/or data stored in memory or a database. Similarly, platform 4 may comprise a number of subsystems 42. Each of these subsystems 42 may comprise one or more processors specially designed and programmed to complete the features and functions described herein by, for example, accessing instructions stored in memory and/or data stored in memory or a database. It should be understood, however, that depending on the feature or function, each of the subsystems 42 need not necessarily include a processor, memory and a database.

In embodiments of the invention, rather than be “always on” each of these systems and subsystems may be configured themselves, and in relation to one another, so that each is activated (i.e., “turned on”) only as needed to provide the functionality required to provide a particular capability (e.g., utility) or service. Examples of such utilities include, but are not limited to “notification” and “binder” utilities. In one embodiment, a notification utility generates notifications or messages that may be sent to, or from, a user. Such notifications may be part of an associated service, for example.

It should be understood that the platform 4 may include one or more databases 41 operable to store information in the form of text, audio, video, image or some combination of such information in a plurality of desired formats for ease of storage, retrieval and eventual usage by the platform and devices described herein. For example, in an embodiment of the invention, the platform 4 may be operable to provide content within databases 41 to a device 2a,2b, . . . 2n, 3a,3b, . . . 3n or 5a, 5b, . . . 5n as part of a content-as-a-service. Such a service may be provided to a user of a device 2a,2b, . . . 2n, 3a,3b, . . . 3n or 5a, 5b, . . . 5n as a standalone service or may be combined with other information and provided to a user of a device 2a,2b, . . . 2n, 3a,3b, . . . 3n or 5a, 5b, . . . 5n where it may be displayed to a user via an interface. Such a content-as-a-service may be combined with one or more other services described herein. Further, content exchanged between the platform 4 and any of the user devices described herein may need to be compressed or decompressed upon transmission or reception to insure an acceptable or high level of data transfer and performance. When required, compression/decompression of content may be performed by one or more techniques known to those skilled in the art.

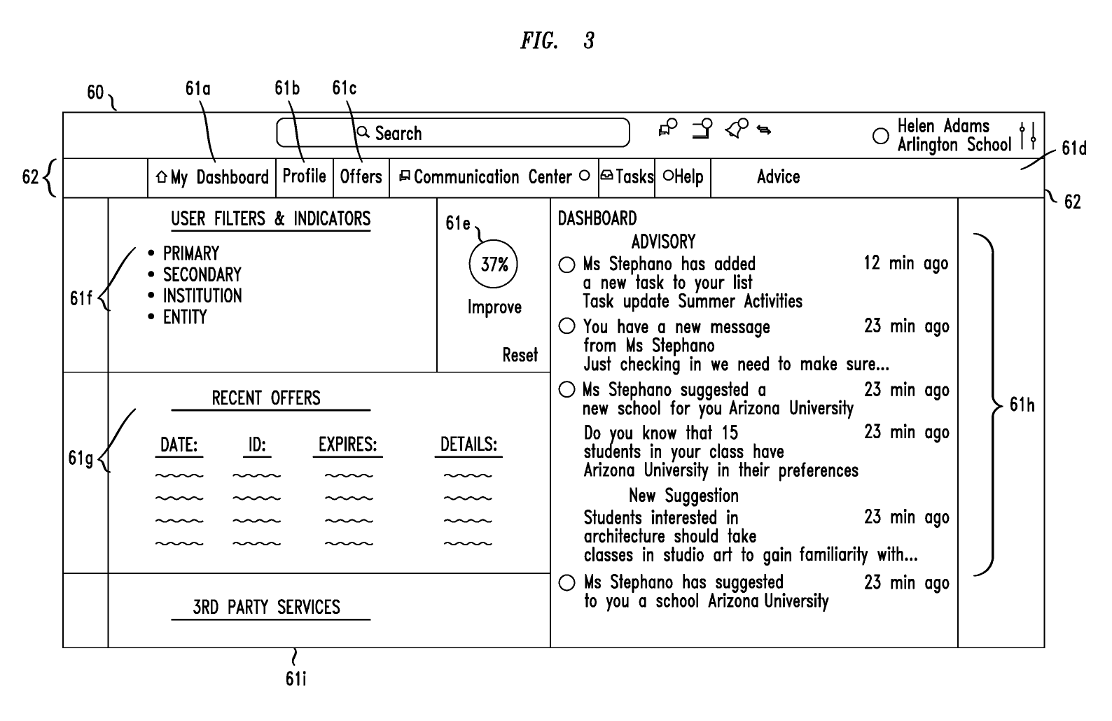

In one embodiment of the invention, servers 42 may be operable to select certain content from databases 41 that the servers 42 have determined best match information a user has provided to the platform 4 (e.g., a user's identity, credentials). By way of non-limiting examples, “credentials” may include a user's accomplishments, skills and capabilities. Platform 4 may be operable to provide a user of a device 2a,2b, . . . 2n, 3a,3b, . . . 3n or 5a, 5b, . . . 5n with content that may be displayed by, or on, an interface of such a device as a “dashboard” (see FIG. 3, for example). Such a dashboard would allow a user to input certain key words or select other types of filters in order to select the type of content he or she desires to view. In embodiments of the invention, the information input by a user into a device 2a, 2b, . . . 2n, 3a,3b, . . . 3n or 5a, 5b, . . . 5n are communicated to the platform 4. Upon receiving this information the platform 4 may be operable to determine which content should be retrieved, and then sent to the user's device 2a, 2b, . . . 2n, 3a,3b, . . . 3n or 5a, 5b, . . . 5n to be displayed by an interface.

It should be understood that the platform 4 and/or a user device 2a, 2b, . . . 2n, 3a,3b, . . . 3n or 5a, 5b, . . . 5n . . . may be operable to store the credentials and identity of a user, as well as other information about a given user or users such as those third party services that the user requires. Together, the user's identity, credentials, and additional information (e.g., third party services required) may form a user profile that may be stored in a database 41 connected to, or associated with, platform 4 or a memory section within device 2a, 2b, . . . 2n, 3a,3b, . . . 3n or 5a, 5b, . . . 5n, or in a third party database (not shown in figures). The profiles may be accessed as part of a process to provide a service to a user using the platform 4 or by a third party service organization (e.g., bank, rental car or truck company, moving company, furniture rental company). The profiles may be updated through communications exchanged by a given user, through communications received from other parts of the system 1, or from external sources (third party).

It should be understood that each of the physical embodiments of the system 1, platform 4, servers 42, devices 2a,2b, . . . 2n, 3a,3b, . . . 3n and 5a,5b, . . . 5n, and databases (e.g., database 41) their elements and other devices described herein are configured with the necessary electronics to enable each to process information much faster than humanly possible and to exchange information with each other much possible than humanly possible. That is to say, each of the embodiments of the present invention cannot practically be implemented in any amount of time that would be acceptable to one skilled in the art using human beings as substitutes for the systems, devices, databases and platforms described herein. For example, many of the embodiments described herein involve an exchange of information via a network between a physical user device and network device that are remotely located from one another, where the information exchanged must be available for immediate display to a user involved in the exchange of information. Accordingly, the speeds at which the information is exchanged, and the amount of information exchanged is many times faster than can be communicated and processed by the human mind. Nor can such information be displayed by the human mind or mechanical means (pen and paper) within the time periods demanded by users of the present invention and those skilled in the art of the present invention.

Unlike existing systems, the systems provided by the present invention are operable to receive a plurality of additional, personalized information from users (e.g., student-users, academic administrator-users, employer-users, trade/vocational users, and financial/resource users) and their related institutions/entities. For example, instead of simply receiving generalized information from a user, systems provided by the present invention may receive in-depth information from users.

System 1 and its related methods may provide a number of services. Collectively, these services may form an online “marketplace” that levels the playing field for individuals applying to an academic, trade or vocational institution, or applying for resource assistance (e.g., financial aid), or applying for an apprenticeship, internship or employment or in need of third party services.

By way of a non-limiting example, embodiments of the present invention provide the systems and methods that allow an individual (“offeree”) that is seeking admission to an academic institution to present their credentials to members (“offerors”) of a plurality of such institutions that are responsible for making admission decisions in order to receive an “offer” of admission, for example. Alternatively, or optionally, systems and methods provided by the present invention may also provide members of an institution (or entity), that are looking for talented individuals, to present their offer and institution (or entity) to such individuals (e.g., students and prospective students) they are interested in making admission offers to, or making resource awards to, to support the institution or entity's continuing mission of excellence. By presenting themselves to each other in this manner allows an individual offeree to select the institution or entity offeror that provides the offeree with the best offer (e.g. most financial aid), while conversely allowing an offeror to attract offerees (e.g., students) that the offeror believes is the best match with for her or his institution or entity, for example.

Additional embodiments of the present invention provide the systems and methods that allow an individual that is seeking services from a third party to request quotations or estimates from third party service providers where the service providers may view each other's process and services on a competitive basis. Alternatively, or optionally, systems and methods provided by the present invention may also provide third party service providers that are interested in selling their services to an individual to present their services and prices to the individual.

In embodiments of the invention, an offer may be made in a number of different ways, including a “double blind matching” method. For example, in an exemplary double blind matching method, initially neither the offeree nor the offeror know each other's identity. However, that may change depending on the offeree's and/or offeror's subsequent actions. In one embodiment, provided the offeree indicates that the offeror (e.g., the offeror's offer, institution, or entity etc. . . . ) is the most desirable and the offeror indicates the offeree (e.g., the offeree's credentials) are the most desirable, then systems and methods provided by the present invention will provide the identity of the offeree is provided to the offeror and the identity of the offeror is provided to the offeree (i.e., the double blinds are “opened” or “lifted”). The offeree and/or offeror may provide such indications by way of using “visibility indicators” that are described in more detail elsewhere herein.

If, however, a particular offeree and a particular offeror do not indicate that each other are the most desirable (i.e., rank each other #1), then systems and methods provided by the present invention may prevent or inhibit the identities of the offeree and offeror from being disclosed to one another (i.e., the identities are not disclosed).

For example, suppose a particular offeree indicates that a particular offeror (e.g., the offeror's offer, institution, or entity etc. . . . ) is the most desirable from the offeree's perspective, but the particular offeror has indicated that the particular offeree (e.g., the offeree's credentials) is not the most desirable from the offeror's perspective. In one embodiment, systems and methods provided by the present invention will prevent or otherwise inhibit the disclosure of the particular offeror's identity to the particular offeree, but may permit or otherwise provide the particular offeree's identity to one or more additional offerors.

More specifically, in an additional embodiment, depending on the configuration selected by the offeree (e.g., the visibility indicators provided by the offeree), upon determining that the particular offeror has not indicated that the particular offeree is the most desirable, systems and methods provided by the present invention may operate in a default mode where the particular offeree's identity is thereafter provided to one or more other offerors who are not the most desirable, Said another way, the offeree may configure the systems provided by the present invention to provide his or her identity to those offerors that are not his or her first choice upon realizing that the offeree's first choice is not (unfortunately) interested in making an offer. In alternative embodiments the identity of the offeree may be provided to additional offerors one-by-one. For example, to the offeror that is the “next” most desirable (i.e., is ranked second by the offeree). Or, the offeree's identity may be provided to a number of additional offerors substantially simultaneously (e.g., to the offerors that the offeree has ranked second through one hundred).

Again, the indications or rankings may be provided using visibility indicators described elsewhere herein.

Similarly, suppose a particular offeror indicates that a particular offeree (e.g., the offeree's credentials) is the most desirable from the offeror's perspective, but the particular offeree has indicated that the particular offeror (e.g., the offeror's offer, institution, or entity, etc. . . . ) is not the most desirable from the offeree's perspective. In one embodiment, systems and methods provided by the present invention will prevent or otherwise inhibit the disclosure of the particular offeree's identity to the particular offeror, but will permit or otherwise provide the particular offeror's identity to one or more additional offerees.

More specifically, in an additional embodiment, depending on the configuration selected by the offeror (e.g., the visibility indicators provided by the offeror), upon determining that the particular offeree has not indicated that the particular offeror is the most desirable, systems and methods provided by the present invention may operate in a default mode where the particular offeror's identity is thereafter provided to one or more other offerees who are not the most desirable, Said another way, the offeror may configure the systems provided by the present invention to provide his or her identity to those offerees that are not his or her first choice upon realizing that the offeror's first choice is not (unfortunately) interested in accepting an offer. In alternative embodiments the identity of the offeror may be provided to additional offerees one-by-one. For example, to the offeree that is the “next” most desirable (i.e., is ranked second by the offeror). Or, the offeror's identity may be provided to a number of additional offerees substantially simultaneously (e.g., to the offerees that the offeror has ranked second through one hundred).

Yet again, it should be understood that the indications or rankings may be provided using visibility indicators described elsewhere herein.

Yet further, in additional embodiments, systems and methods provided by the present invention may be operable to disclose the identity of a particular offeree to one or more particular offerors (e.g., all offerors) initially or at any time depending on how a given system is configured (e.g., depending on the visibility indicators selected by the offeree). In other words, a system may be configured to operationally “suspend” or operationally not use a double blind matching methodology based on a configuration selected by the offeree. Similarly, systems and methods provided by the present invention may be operable to disclose the identity of a particular offeror to one or more particular offerees (e.g., all offerees) initially or at any time depending on how a given system is configured (e.g., depending on the visibility indicators selected by the offeror). In other words, a system may be configured to operationally suspend or operationally not use a double blind matching methodology based on a configuration selected by the offeror.

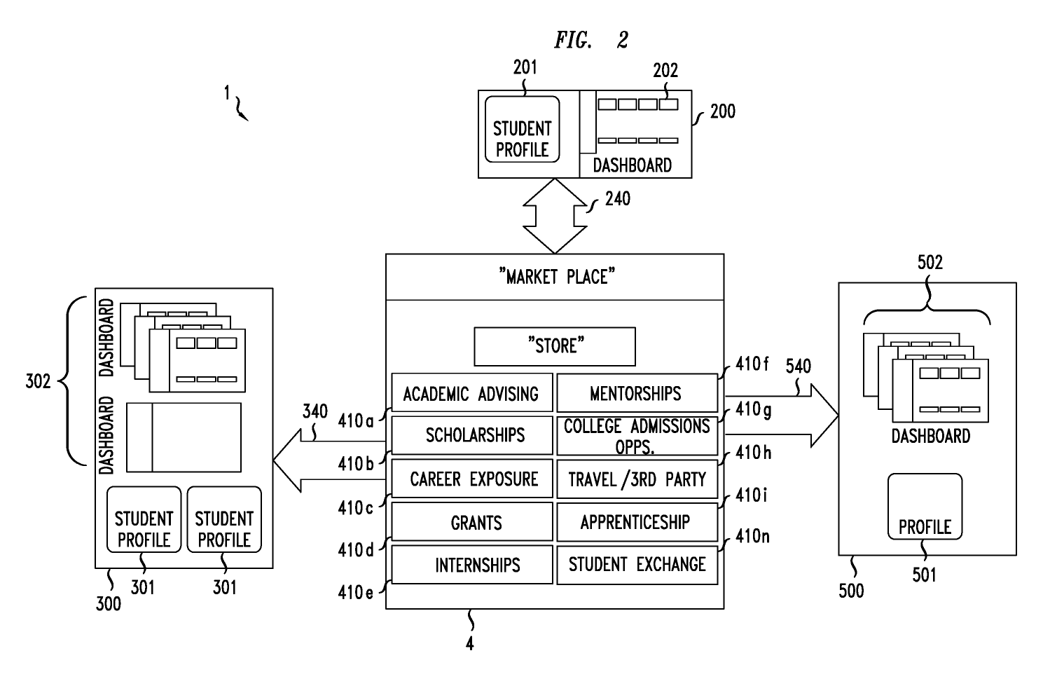

Referring now to FIG. 2 there is depicted another version of a block diagram of the system 1 according to an embodiment of the invention. As shown, the system 1 comprises the platform 4, offeree user device 200, offeror user device 300 and a consultant user device 500. To simplify the explanation that follows only single user devices 200, 300 and 500 are shown, it being understood that a plurality of user devices like those illustrated in FIG. 1 may be used in conjunction with platform 4.

As indicated previously and elsewhere herein, and now illustrated in FIG. 2, the platform 4 may be operable to provide a number of different types of services to offerees, offerors, consultants and third party service providers. For example, platform 4 may be operable to provide academic advising, scholarship related, career exposure related, grant related, internship related, mentorship related, college admission based, travel related (and other third party services), apprenticeship related, and student exchange services 410 a-n (where “n’ is the last type of service), to name just a few types of services that may be provided by platform 4. Collectively, the services 410a-n provided by platform 4 may be viewed as creating a “marketplace” where individuals (offerees), entities (offerors), consultants and third party service providers may participate in the marketplace by engaging in, or selecting, a service 410a-n from among those provided by the platform 4, analogous to selecting a product from a “store”.

FIG. 2 depicts a high-level, exemplary representation of an offeree user device 200 that may be operable to exchange information with the platform 4 via communication link 240, for example. The device 200 may comprise a wired or wireless device operable to transmit information identifying the offeree using device 200, the offeree's credentials and one or more primary and secondary, offeree visibility indicators to platform 4 (hereafter “primary” or “secondary” offeree indicators). Further, the device 200 may be operable to receive the identity of an offeror associated with device 300 and the offeror's associated offer (as well as receive the identity of each offeror associated with additional devices and their respective, associated offers) as well as receive the identity of a consultant associated with device 500 and information from the consultant and the identity of, and services offered by, a third party service provider (not shown in figures)

In embodiments of the invention, the offeree visibility indicators are provided by the offeree (e.g., student) to the platform 4 and are intended to act as instructions from the offeree to the platform 4 governing how the platform 4 is to treat the offeree's identity and credentials. Said another way, the offeree can control the distribution of her or his identity and credentials by sending certain visibility indicators or values to the platform 4. In one embodiment, a first or primary indicator or value instructs the platform 4 to distribute (or otherwise make known) the offeree's identity and credentials to a number of offerors (e.g., administrators of an institutions, potential employers), consultants and/or third party service providers, where the number of offerors, consultants and/or third party service providers may be 0, 1 or more than 1 while a second or secondary indicator or value instructs the platform 4 to inhibit or otherwise prevent the distribution of (or otherwise keep secret or confidential) the offeree's identity and credentials from a number of offerors, consultants or third party service providers, where the number of offeror, consultants or third party service providers may be 0, 1 or more than 1.

More particularly, in an embodiment of the invention primary, offeree visibility indicators are selected or otherwise input into device 200 by a user via interface 202 and then sent or otherwise provided to the platform 4 via communications link 240. As previously explained, the primary offeree indicators indicate whether or not the identity of the user of device 200 (i.e., the offeree) and such a user's (offeree's) credentials should, or should not, be provided to a number of offerors, consultants and/or third party service providers, such as the offeror associated with device 300 or the consultant associated with device 500. Further, secondary offeree visibility indicators indicate whether or not the identity of the user of device 200 (the offeree) should, or should not, be provided to a number of other offerees, consultants (not shown in FIG. 2; e.g., offeree devices 2a, 2b, . . . 2n, consultant devices 5a, 5b, . . . 5n in FIG. 1) or third party service providers (not shown in figures).

Also shown in FIG. 2 is a high-level, exemplary representation of an offeror user device 300 that may be operable to exchange information with the platform 4 via communication link 340, for example. The device 300 may comprise a wired or wireless device that is operable to receive the identity of one or more offerees, such as the offeree of device 200, as well as the offeree's credentials, receive the identity of a consultant associated with device 500 and information from the consultant and receive the identity of, and services offered by, a third party service provider (not shown in figures). In addition, the device 300 may be operable to transmit information regarding the identity of the offeror of the device 300 and their related institution/entity, an offer associated with the offeror (“associated offer”) and one or more primary and secondary, offeror visibility indicators to the platform 4.

Similar to the description of offeree visibility indicators, in embodiments of the invention, the offeror visibility indicators are provided by each offeror (e.g., administrator of an academic institution, individual responsible for hiring new employees) to the platform 4 and are intended to act as instructions from each offeror to the platform 4 governing how the platform is to treat the offeror's identity and associated offer. Said another way, the offeror of device 300 can control the distribution of their identity and associated offer by sending certain visibility indicators or values to the platform 4. In one embodiment, a first or primary indicator or value instructs the platform 4 to distribute (or otherwise make known) the offeror's identity and associated offer to the offeree (e.g., student applying to the academic institution, individual applying for a job, apprenticeship, internship) or a number of offerees) consultants and/or third party service providers, where the number of offerees, consultants and/or third party service providers may be 0, 1 or more than 1 while a second or secondary indicator or value instructs the platform 4 to inhibit or otherwise prevent the distribution (or otherwise keep secret or confidential) the offeror's identity and associated offer from a number of offerees, consultants and/or third party service providers, where the number of offerees, consultants and/or third party service providers can be 0, 1 or more than 1.

More particularly, in an embodiment of the invention primary, offeror visibility indicators are selected or otherwise input into device 300 by a user via interface 302 and then sent or otherwise provided to the platform 4 via communications link 340. As previously explained, the primary offeror indicators indicate whether or not the identity of the user of device 300 (i.e., the offeror, or the institution or entity represented by the offeror) and such a user's (offeror's) associated offer should, or should not, be provided to the offeree using device 200 (or to a number of offerors), a consultant using device 500 (and/or a number of consultants) and/or third party service provider devices (not shown in figures). Further, secondary offeror visibility indicators indicate whether or not the identity of the user of device 300 (the offeror) should, or should not, be provided to a number of other offerors, consultants and/or third party service providers (not shown in FIG. 2; e.g., offeror devices 3a, 3b, . . . 3n, consultant devices 5a, 5b, . . . 5n).

Still further, similar to the description of offeree and offeror visibility indicators, in embodiments of the invention, consultant visibility indicators are provided by each consultant (e.g., academic, social, financial, employment consultant or advisor) to the platform 4 and are intended to act as instructions from each consultant to the platform 4 governing how the platform is to treat the consultant's identity and associated advice. Said another way, the consultant associated with device 500 can control the distribution of her or his identity and associated advice by sending certain visibility indicators or values to the platform 4. In one embodiment, a first or primary indicator or value instructs the platform 4 to distribute (or otherwise make known) the consultant's identity and associated advice to a number of offerees and/or offerors, where the number of offerees and/or offerors can be 0, 1 or more than 1 while a second or secondary indicator or value instructs the platform 4 to inhibit or otherwise prevent the distribution (or otherwise keep secret or confidential) the consultant's identity and associated advice from a number of offerees and/or offerors, where, again, the number of offerees, offerors, consultants and/or third party service providers can be 0, 1 or more than 1.

More particularly, in an embodiment of the invention primary, consultant visibility indicators are selected or otherwise input into device 500 by a user via interface 502 and then sent or otherwise provided to the platform 4 via communications link 540. As previously explained, the primary consultant indicators indicate whether or not the identity of the user of device 500 (i.e., the consultant, or the institution or entity represented by the consultant) and such a user's (consultant's) associated advice should, or should not, be provided to the offeree using device 200 (or to a number of offerees) and/or to an offeror using device 300 (and/or a number of offerors). Further, secondary consultant visibility indicators indicate whether or not the identity of the user of device 500 (the consultant) should, or should not, be provided to a number of other consultants (not shown in FIG. 2; e.g., devices 5a, 5b, . . . 5n in FIG. 1).

After receiving information, the platform 4 may be operable to: (i) determine whether to provide the identity of the offeree and the offeree's credentials to one or more offerors 3a,3b, . . . 3n, other offerees 2a,2b, . . . 2n, consultants 5a,5b, . . . 5n and/or third party service providers (not shown in figures) based on the value of the one or more offeree visibility indicators; (ii) determine whether to provide the identity of the offeror and the offeror's associated offer to the offeree (or more than one offeree), other offerors 3a,3b, . . . 3n, consultants 5a, 5b, . . . 5n or third party service providers based on the value of the one or more offeror visibility indicators; and (iii) determine whether to provide the identity of the consultant and the consultant's associated advice to the offeree (or more than one offeree), to the offeror or offerors 3a,3b, . . . 3n or to other consultants 5a, 5b, . . . 5n based on the value of the one or more consultant visibility indicators.

Continuing with a description of the high level system 1 depicted in FIG. 2, as shown each of the devices 200, 300, 500 may (and typically will) include an interface 202, 302, 502, respectively. As explained elsewhere herein, and now reiterated herein, each of the interfaces 202, 302, 502 may be operable to generate and display a dashboard that allows the user of device 200, 300, 500 to input information that is eventually sent to the platform 4 (e.g., identities credentials, offers, and visibility indicators), to view information that is sent from platform 4 (e.g., identities credentials, offers, and visibility indicators) and view information that may be sent from one or more additional user devices 2a,2b, . . . 2n, 3a,3b, . . . 3n and 5a,5b, . . . 5n.

In addition to an interface, each of the devices 200, 300, 500 may (and typically will) include a memory section 201, 301, 501 (e.g., memory circuitry, standalone memory(s), database(s)) for storing information. Exemplary information may (and typically will) include one or more profiles that may contain one or more of the following exemplary types of information: identity, credentials, offers, visibility indicators and third party services requested or needed. As mentioned previously, the profiles may be accessed as part of a process to provide a service to a user, and may be updated through communications exchanged by a given user with other parts of the system 1, or with external sources (not shown in FIG. 2).

While FIG. 2 depicts each device 200,300,500 as having a single memory section 201,301,501 it should be understood that this is for illustrative purposes only, it being understood that each device may be operable to include as much memory capacity as is needed to complete the features and functions of the present invention and their equivalents. In addition, each device may store a plurality of profiles such as user profiles (i.e., profiles of the user of a respective device) as well as additional profiles. For example, an offeree or user of device 200 may store their own profile, profiles of offerors and their related institutions or entities, profiles of other offerees and profiles of consultants, and profiles of third party service providers while an offeror or user of device 300 may store their own profile, profiles of offerees, profiles of other offerors and their related institutions or entities, profiles of consultants and profiles of third party service providers. Similarly, a consultant or user of device 500 may store their own profile, profiles of offerees, profiles of offerors and their related institutions or entities, and profiles of other consultants.

As indicated previously, and now reiterated herein, unlike existing systems, the systems provided by the present invention are operable to store profiles that include a vast array of personalized, user and institution/entity information. For example, instead of simply exchanging and storing generalized information that can be processed and indicates a student-user is interested in a 2 or 4 year college, for example, systems provided by the present invention may exchange and store information that indicates in-depth information about a student's preferences, and an institution/entities' environment, such as the size of the college, its physical environment (urban, city or country), and geographical location (East coast, West coast, Midwest, closeness to parks, water, etc.,) to name to just few of the many types of personalized information. Other types of personalized information, such as the institution/entity's social environment (e.g., closeness to arts, museums, music centers or music scene), a student-user's academic record (e.g., grades in high school, college), results of standardized tests (e.g. SAT, ACT) and advanced placement (AP) courses completed/test results may be exchanged and stored in a profile as well. In sum, a wide variety of additional, personalized information that is specific to a given type of user/institution/entity may be exchanged and stored by the platform 4, devices 200,300,500 and third party service provider devices (not shown in figures). It should be understood that the additional, personalized student-user information need not be limited to high school or college information. Other types of information include, but are not limited to graduate school, professional, apprenticeship, life-style or health information, to name just a few additional examples.

Though FIGS. 1 and 2 depict offerors and consultants as being separate and distinct entities, it should be understood that in some instances an offeror and consultant may be one and the same entity or individual. For example, an academic or trade institution (offeror) may employ consultants. In such a case, the features and functions completed by devices 300,500 may be combined or overlap to one extent or another (i.e., partially or entirely). Said another way, either device 300, 500 may be operable to complete the features and functions of both devices, respectively. Further, though not typical, an offeree (e.g., student) may be granted privileges of a consultant, either an independent one or one acting on behalf of an institution or entity. For example, an individual that has used the platform 4 previously as an offeree (e.g., student) may be asked by their institution or entity to assist the institution or entity in recruiting new offerees (e.g., students, employees). In such a case, the features and functions completed by devices 200, 300,500 may be combined or overlap to one extent or another (i.e., partially or entirely). Said another way, any one of device 200, 300, 500 may be operable to complete the features and functions of another device, respectively.

An exemplary dashboard 60 according to one or more embodiments of the invention is depicted in FIG. 3. Dashboard 60 may be generated by an interface, such as a GUI, that is a part of a device 200,300,500. Dashboard 60 (and, therefore, its associated interface) may be operable to allow a user of device 200, 300, 500 to input information that is eventually sent to the platform 4 (e.g., identities credentials, offers, and visibility indicators), to view information that is sent from platform 4 (e.g., identities credentials, offers, and visibility indicators) and to view information that may be sent from one or more additional user devices (e.g., devices 2a,2b, . . . 2n, 3a,3b, . . . 3n and 5a,5b, . . . 5n).

For present purposes we will focus on an offeree type device, it being understood that the following description may be applied to offeror and consultant type devices as well albeit modified to be consistent with the description elsewhere herein.

Dashboard 60 comprises a dashboard that may be utilized by an offeree using device 200 or 2a,2b, . . . 2n. In embodiments of the invention, dashboard 60 may comprise a plurality of sections 61a to 61n (where “n” denotes the last section), each of which may be displayed by its respective interface using information that is (a) input by an offeree, (b) received from platform 4, (c) received from an offeror, consultant or another offeree, (d) received from another external source (e) generated by the device 200 based on information from sources (a) to (d) or (f) based on some combination of sources (a) to (e), for example.

In an embodiment of the invention exemplary sections 61a to 61h may comprise the following: a “My Dashboard” tab 61a. “Profile Detail” tab 61b, “Offers” tab 61c, and “Advice” tab 61d that are all a part of a tab section 62; a “percent” or “%” “Profile Completed” section 61e; a “User Filters & Indicators” section 61f; a “Recent Offers” section 61g; an “Advisory” section 61h and a “3^{rd} Party Services” section 61i, to name just a few of the many sections that may be a part of dashboard 60 upon being displayed by the user interface that is a part of offeree device 200, for example.

The following is a brief description of each exemplary section 61a-61i (including 62) depicted in FIG. 3, it being understood that the description that follows is not an exhaustive description, rather an illustrative description, of the sections that may be displayed as a part of dashboard 60 by devices and methods provided by the present invention.

An exemplary “My Dashboard” tab 61a displays sections 61a through 61h (inclusive of 62). An exemplary “Profile Detail” tab 61b, when selected by a user may display the details of a user's profile, including the identity and credential information the user has previously input. This section may further display profile information about an offeror and the academic institution, business entity or other entity and institution that the offeror represents, information about a consultant and information about other offerees, for example. An exemplary “Offers” tab 61c may display those offers an offeree has received from offerors, including, but not limited to, the identity of each offeror (if authorized by an offeror), each offeror's associated offer made to the offeree (again, if authorized by a respective offeror). The offers may be displayed using a number of different, user selectable categories, including, but not limited to: “recent” offers to “oldest” offers, offers listed by greatest consideration (e.g., monetary) amount to least consideration, by offeror name, and by offeror location or may be displayed using a dashboard default category.

The information displayed by the dashboard 60 may be displayed in an enhanced manner in order to draw the information to the attention of a user. For example, certain user designated, important or priority information within sections 61a to 61h may be displayed in a bold typeface, in a color other than black and white, in a highlighted background, in a larger font or in conjunction with a marker of some sort, such as asterisks, exclamation points, warning/reminder symbols or warning/reminder notices, for example.

An exemplary “Advice” tab 61d may display the information that has been received by the offeree from consultants, offerors or other offerees, or third party sources, including, but not limited to, the identity of each individual (consultant, advisor, etc.,) offering advice (if authorized), and each individual's associated advice (again, if authorized). The advice may be displayed using a number of different, user selectable categories, including, but not limited to: “recent” advice to “oldest” advice, advice by individual's name, or may be displayed using a dashboard default category.

An exemplary “percent” or “%” “Profile Completed” section 61e may display the status of a user's profile as it relates to whether or not the user has input the required information requested by the device 200 and/or platform 4 in order to complete his or her profile. For example, a displayed indication of “37%” means the user has input information that satisfies 37 percent of the information necessary to complete a detailed (i.e., complete) user profile.

An exemplary “User Filters & Indicators” section 61f may display a plurality of selectable filters and indicators to assist the offeree in identifying offers of interest, for example. Some exemplary filters and indicators may be those that allow the offeree the ability to: select the academic institutions or corporate entities the offeree wishes to send her credentials to in order to receive offers of admission into the institutions or offers of employment from the entities; select one or more visibility indicators to allow one or more offerors, offerees, consultants and/or third party service providers to see the offeree's identity and credentials, for example, to name just two of the many types of filters and indicators that may be displayed to the offeree using device 200.

Section 61g is a “Recent Offers” section. In an embodiment of the invention, an exemplary Recent Offers section 61g may comprise a listing of those offers received from an offeror with the most recent (“newest”) offer listed first and the “oldest” offer listed last. In addition, this section 61g may display details of each offer (to the extent the offeror has authorized the disclosure of the following information), such as the date the offer was made to the offeror, identity of the offeror, contact information for the offeror so the offeree can respond to the offer, an “expiration” date for the offer (i.e., a date by which the offeree must accept the offer or the offer expires), the name of the entity or institution the offeror represents, any consideration associated with the offer (e.g., monetary financial aid or salary), the timing of the offer (e.g., date employment begins or the date the financial aid is available), and, of course, admission and employment messages (e.g., welcome to the class of 2020!!, congratulations on being hired as our newest service technician).

An exemplary “Advisory” section 61h may display (to the extent an advisor or consultant has authorized the disclosure of the following information) the identification of the advisor/consultant, the advisor/consultant's contact information, and the content of a message from the advisor/consultant to the offeree, for example, to name just a few of the many different types of information that may be displayed by the Advisory section 61h.

The “3^{rd} Party Services” section 61i may display the identification of one or more third party service providers (e.g., moving companies, furniture rental companies, rental car companies, telephone, Internet and cable companies, computer and software vendors, cleaning services, Uber and taxi cab services), their contact information, availability and prices.

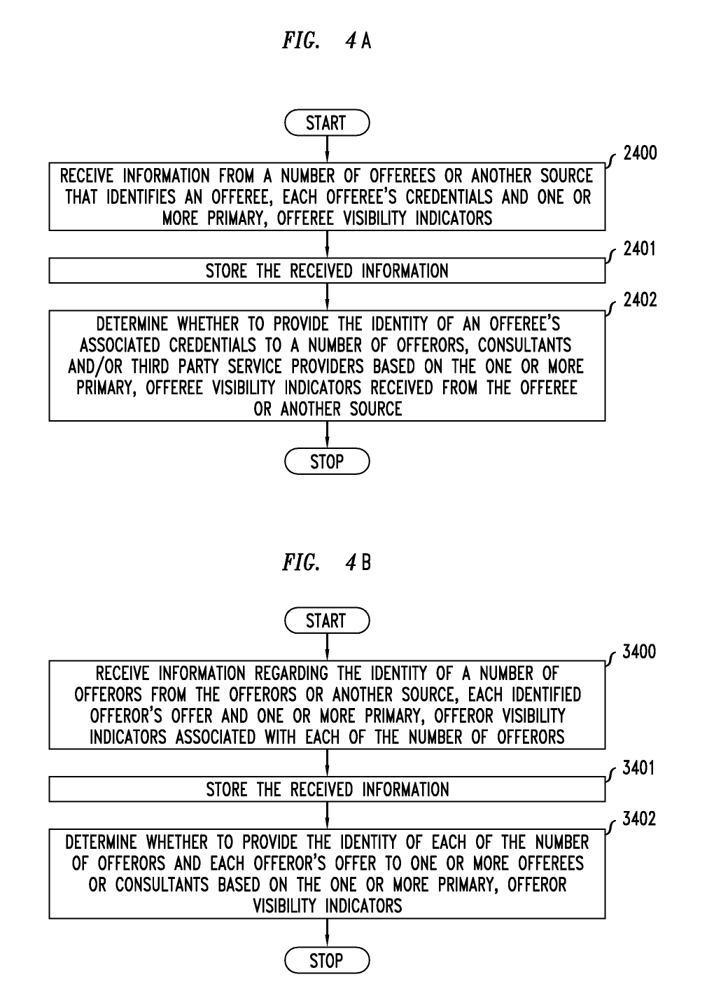

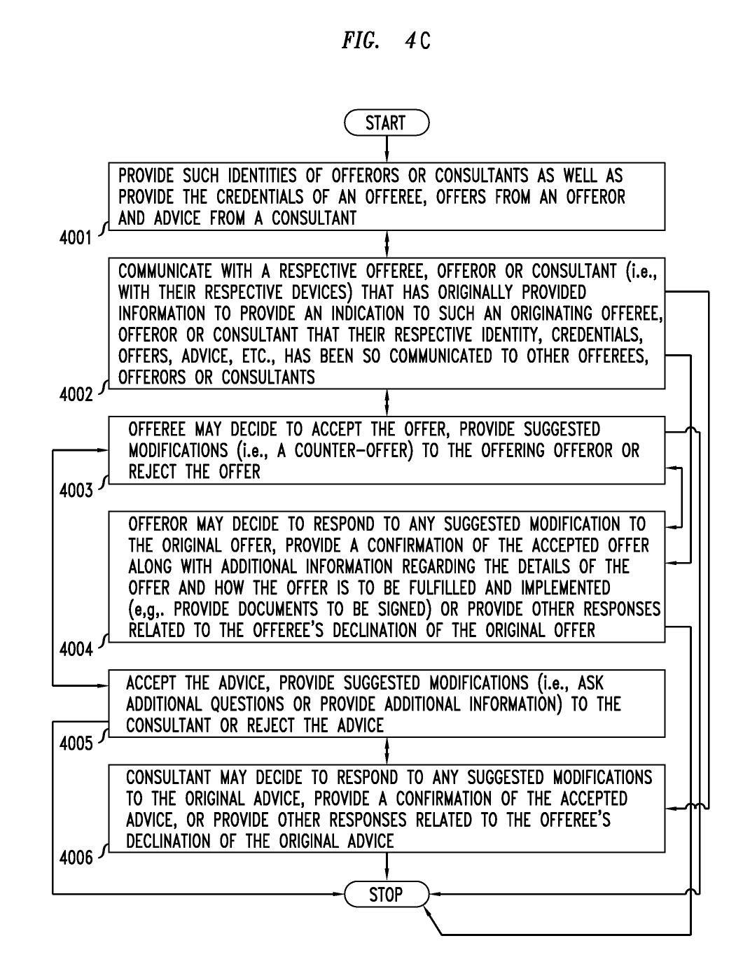

Referring now to FIG. 4A there is depicted an exemplary flow diagram according to one or more embodiments of the present invention. In one embodiment a platform 4 comprising, for example, a network hardware platform, may be operable to receive information from a number of offerees (e.g., 2a, 2b, . . . 2n or 200) or another source that identifies an offeree, each offeree's credentials (e.g., the offeree's academic record, life experiences) and one or more primary, offeree visibility indicators for each offeree in step 2400 and store the received information in step 2401 and then determine whether to provide the identity of an offeree and the offeree's associated credentials to a number of offerors 3a,3b, . . . 3n, consultants 5a, 5b, . . . 5n and/or third party service providers based on the one or more primary, offeree visibility indicators received from the offeree or another source in step 2402. As explained previously, the one or more primary, offeree visibility indicators may include one or more indicators or values that indicate whether the offeree's identity and credentials should, or should not, be provided to a number of offerors, consultants and/or third party service providers.

The “number” of offerees, offerors and consultants may be 0, 1 or more than 1. That is to say, the indicators may indicate that a particular offeree's identity and credentials may not be disclosed to any offerors, consultants and/or third party service providers, to only one offeror, consultant and/or third party service providers or to more than one offeror, consultant and/or third party service providers (e.g., all offerors, consultants and/or third party service providers or some smaller subset of available offerors, consultants and/or third party service providers). In this manner an offeree can control the distribution of their identity and credentials in order to target only those institutions or entities, for example, of greatest interest to the offeree (e.g., those academic institutions the offeree is most interested in applying to, those companies the offeree is most interested in working for). Alternatively, the offeree can control the negotiations with third party service providers and, ideally, force such providers to be more competitive in the pricing and services they provide to the offeree.

As described elsewhere herein, and now further reiterated, an offeror may be a representative, agent or employee (collectively “member”) of a number of different types of institutions and entities, including, but not limited to, a member of an academic institution, trade or vocational institution, a trade or vocational occupation or an employer. In some instances, an offeror may be a consultant and third party service provider as well.

Depending on the value, state or content of the primary, visibility indicators received by the platform 4, information about an offeree 2a, 2b, . . . 2n and 200 may, or may not, be disclosed to an offeror, consultant and/or third party service provider. There are many variations and levels of disclosure that the offeree may choose. For example, in embodiments of the invention in step 2400 an offeree may choose to send one or more primary, visibility indicators to the platform 4, including one or more that indicate: (i) the identity of the offeree should be provided to a number of offerors, consultants and/or third party service providers; (ii) the identity of the offeree should not be provided to a number of offerors, consultants and/or third party service providers; (iii) the offeree's credentials should be provided to a number of offerors, consultants and/or third party service providers; and/or (iv) the credentials should not be provided to a number of offerors, consultants and/or third party service providers, where, again the “number” of offerors, consultants and/or third party service providers may be 0, 1 or more than 1 (where 1 may be the double blind matching scenario discussed elsewhere herein).

Upon receiving the primary offeree visibility indicators from an offeree 2a, 2b, . . . 2n or 200 the platform 4 is operable to store the received indicators in step 2401 and determine whether information about a respective offeree may be disclosed based on the value of the indicators associated with the respective offeree in step 2402. The indicator values may take the form of many different types of electronic signals known to those in the art it being understood that a different value is associated with a different level of disclosure (e.g., no disclosure, limited disclosure, or wide disclosure of an offeree's identity and/or credentials to 0, 1 or more than 1 offeror, consultant and/or third party service provider). Upon determining the level of disclosure associated with the received primary, offeree visibility indicators associated with each respective offeree the platform 4 may be operable to complete a plurality of functions, including, but not limited to the following: (i) provide the identity of a respective offeree to a number of offerors, consultants and/or third party service providers; (ii) inhibit the provisioning of the identity of the offeree to the number of offerors, consultants and/or third party service providers; (iii) provide the offeree's credentials to a number of offerors and/or consultants; and/or (iv) inhibit the provisioning of the credentials to the number of offerors and/or consultants (where, again, 1 may be the double blind matching scenario discussed elsewhere herein).

In addition to providing embodiments that permit an offeree to control how their identity and credentials will be distributed to offerors, consultants (using primary visibility indicators) and/or third party service providers, the present invention provides for embodiments that permit an offeree to control how their identity and credentials will be distributed to other offerees, such as those offerees that may be competing for the same position offered by the same prospective employer, or the same admission opening available from the same academic institution, for example. In such scenarios the offeree may wish to limit the distribution of their identity and credentials. Still further, other competitive and confidentiality considerations may concern the offeree and cause the offeree to decide to limit disclosure of their identity and credentials to other offerees.

Realizing this, the present invention provides embodiments that permit an offeree to control how their identity and credentials will be distributed to other offerees. In one embodiment, secondary, offeree visibility indicators are used to indicate the level of disclosure. For example, the platform 4 may be operable to receive one or more secondary, offeree visibility indicators from a number of offerees (i.e., offeree device 2a, 2b, . . . 2n or 200) in step 2400 where the indicators include an indicator that indicates the level of disclosure for each associated offeree, store the received indicators in step 2401 and then determine whether to provide the identity of a respective offeree and the offeree's credentials to a number of other offerees (2a,2b, . . . 2n or 200) based on the level of disclosure indicated by the received secondary, offeree visibility indicators of each offeree in step 2402. Similar to the descriptions above, the number of offerees providing the information and “other” offerees authorized to receive the information may be 0, 1 or more than 1 (where 1 may be the double blind matching scenario discussed elsewhere herein).

Upon receiving the secondary, offeree visibility indicators the platform 4 may be operable to store the received indicators in step 2401 and determine whether information about a respective offeree may be disclosed based on the value of the indicators associated with that respective offeree in step 2402. Again, the indicator values may take the form of many different types of electronic signals known to those in the art it being understood that a different value is associated with a different level of disclosure (e.g., no disclosure, limited disclosure, or wide disclosure of the offerees identity and/or credentials to 0, 1 or more than 1 additional offerees). Upon determining the level of disclosure associated with the received secondary, offeree visibility indicators associated with a respective offeree, the platform 4 may be operable to complete a plurality of functions, including, but not limited to the following: (a) provide the identity of a respective offeree to a number of other offerees; (b) inhibit the provisioning of the identity of the offeree to the number of other offerees; (c) provide the offeree's credentials to a number of other offerees; and/or (iv) inhibit the provisioning of the credentials of the offeree to the number of other offerees (where 1 may be the double blind matching scenario discussed elsewhere herein).

For the most part the discussion immediately above is concerned with controlling the level of disclosure of an offeree's information. The present invention is not so limited, however. Additionally, the present invention provides embodiments that permit an offeror and/or consultant to control the level of disclosure of their information as well to offerees, other offerors and/or other consultants. For example, an offeror or consultant may decide for competitive or confidentiality reasons to limit the distribution and disclosure of their identity, offer or advice. In such scenarios an offeror or consultant may wish to limit the distribution of their identity, offer or advice. Still further, other competitive and confidentiality considerations may concern the offeror or consultant and cause the offeror or consultant to decide to limit disclosure of their identity, offer or advice.

Accordingly, referring now to FIG. 4B there is depicted another exemplary flow diagram according to one or more embodiments of the present invention. In the embodiment illustrated by FIG. 4B the platform 4 may be operable to receive information regarding the identity of a number of offerors (e.g. 3a,3b, . . . 3n or 300) from the offerors 3a,3b, . . . 3n, 300 or another source, each identified offeror's offer and one or more primary, offeror visibility indicators associated with each of the number of offerors in step 3400. Upon receiving this information, the platform 4 may be further operable to store the received information in step 3401 and then determine whether to provide the identity of each of the number of offerors and each offeror's offer to one or more offerees 2a, 2b, . . . 2n or 200 or consultants 5a,5b, . . . 5n based on the one or more primary, offeror visibility indicators in step 3402.

The one or more primary, offeror visibility indicators may include one or more indicators or values that indicate whether each offeror's identity and offer(s) should, or should not, be provided to a number of offerees or consultants, where the number of offerees or consultants may be 0, 1 or more than 1. That is to say, the indicators may indicate that an offeror's identity and offers may not be disclosed to any offerees or consultants, to only one offeree and/or consultant or to more than one offeree and/or consultant (e.g., all offerees and consultants or some smaller subset of available offerees or consultants). In this manner an offeror can control the distribution of their identity and offers in order to target only those individuals (e.g., students), for example, of greatest interest to the offeror such as those students the offeror is most interested in admitting to its academic institution or that individual an employer is most interested hiring as an employee.

Thus, depending on the value, state or content of the primary, visibility indicators received by the platform 4, information about a respective offeror 3a, 3b, . . . 3n and 300 may, or may not, be disclosed to an offeree or consultant. There are many variations and levels of disclosure that an offeror may choose. For example, in embodiments of the invention an offeror may choose to send one or more primary, visibility indicators to the platform 4, including one or more that indicate: (i) the identity of the offeror should be provided to a number of offerees and/or consultants; (ii) the identity of the offeror should not be provided to a number of offerees and/or consultants; (iii) the offeror's offer(s) should be provided to a number of offerees and/or consultants; and/or (iv) the offer(s) should not be provided to a number of offerees and/or consultants, where, again the “number” of offerees and/or consultants may be 0, 1 or more than 1 (where, again, 1 may be the double blind matching scenario discussed elsewhere herein).

Upon receiving the primary offeror visibility indicators from an offeror 3a, 3b, . . . 3n or 300 the platform 4 is operable to store the received information in step 3401 and determine whether information about a respective offeror may be disclosed based on the value of the indicators associated with the respective offeror in step 3402. The indicator values may take the form of many different types of electronic signals known to those in the art it being understood that a different value is associated with a different level of disclosure (e.g., no disclosure, limited disclosure, or wide disclosure of the offerors identity and/or offers to 0, 1 or more than 1 offeree and/or consultant). Upon determining the level of disclosure associated with the received primary, offeror visibility indicators associated with a respective offeror the platform 4 may be operable to complete a plurality of functions, including, but not limited to the following: (i) provide the identity of a respective offeror to a number of offerees and/or consultants; (ii) inhibit the provisioning of the identity of the offeror to the number of offerees and/or consultants; (iii) provide the offeror's offers to a number of offerees and/or consultants and/or (iv) inhibit the provisioning of the offers to the number of offerees and/or consultants (where 1 may be the double blind matching scenario discussed elsewhere herein).

In addition to providing embodiments that permit an offeror to control how their identity and offers will be distributed to offerees and consultants (using primary visibility indicators), the present invention provides for embodiments that permit an offeror to control how their identity and offers will be distributed to other offerors, such as those offerors that may be competing for the same students that are applying for admission (or resources, e.g., financial aid) to an academic institution represented by the offeror or the same individuals that are applying for a position as an employee in the entity represented by the offeror, for example. In such scenarios an offeror may wish to limit the distribution of their identity, the identity of the institution or entity they represent and their associated offers. Still further, other competitive and confidentiality considerations may concern the offeror and cause the offeror to decide to limit disclosure of their identity, the identity of the institution or entity they represent and associated offers to other offerors.

Realizing this, the present invention provides embodiments that permit an offeror to control how their identity, their institution/entity's identity and offers will be distributed to other offerors. In one embodiment, secondary, offeror visibility indicators are used to indicate the level of disclosure. For example, the platform 4 may be operable to receive one or more secondary, offeror visibility indicators from a number of offerors (i.e., offeree device 2a, 2b, . . . 2n or 200) where the indicators include an indicator that indicates the level of disclosure for each respective offeror's information, and then determine whether to provide the identity of a respective offeror and the offeror's offer(s) to a number of other offerors (3a,3b, . . . 3n or 300) based on the level of disclosure indicated by the received secondary, offeror visibility indicators. Similar to the descriptions above, the number of other offerors providing information and the number of “other” offerors authorized to receive the information may be 0, 1 or more than 1 (where, again, 1 may be the double blind matching scenario discussed elsewhere herein).

Upon receiving the secondary, offeror visibility indicators in step 3400 the platform 4 may be operable to store the received indicators in step 3401 and determine whether information about a respective offeror may be disclosed based on the value of the respective offeror's associated indicators in step 3402. Again, the indicator values may take the form of many different types of electronic signals known to those in the art it being understood that a different value is associated with a different level of disclosure (e.g., no disclosure, limited disclosure, or wide disclosure of the offerors identity, the identity of the institution/entity represented by the offeror, and/or offers to 0, 1 or more than 1 additional offeror). Upon determining the level of disclosure associated with the received secondary, offeror visibility indicators associated with each respective offeror, the platform 4 may be operable to complete a plurality of functions, including, but not limited to the following: (a) provide the identity of a respective offeror and the institution/entity represented by the offeror to a number of other offerors; (b) inhibit the provisioning of the identity of the offeror and the institution/entity represented by the offeror to the number of other offerors; (c) provide the offeror's offer(s) to a number of other offerors; and/or (iv) inhibit the provisioning of the offers to the number of other offerors (where 1 may be the double blind matching scenario discussed elsewhere herein).

We next discuss embodiments directed to consultants. Though a flow diagram of such embodiments is not shown in FIGS. 4A and 4B (as well as 4C) it should be understood that the process is similar (though not identical to) to the process used by an offeror. Accordingly, in one embodiment the platform 4 may be operable to receive information regarding the identity of a number of consultants (e.g. 5a, 5b, . . . 5n or 500) from the consultants 5a,5b, . . . 5n, 500 or another source, each identified consultant's advice or messages and one or more primary, consultant visibility indicators associated with each of the number of consultants. Upon receiving this information, the platform 4 may be further operable to determine whether to provide the identity of a number of consultants and each consultant's advice or message to one or more offerees 2a, 2b, . . . 2n or 200 or offerors 3a,3b, . . . 3n based on the one or more primary, consultant visibility indicators.

The one or more primary, consultant visibility indicators may include one or more indicators or values that indicate whether a consultant's identity and advice/message(s) should, or should not, be provided to a number of offerees or offerors, where the number of offerees or offerors may be 0, 1 or more than 1. That is to say, the indicators may indicate that a consultant's identity and advice/message(s) may not be disclosed to any offerees or offerors, to only one offeree and/or offeror or to more than one offeree and/or offeror (e.g., all offerees and offerors or some smaller subset of available offerees or offerors). In this manner a consultant can control the distribution of their identity and advice/message(s) in order to target only those individuals (e.g., students) or institutions/entities, for example, of greatest interest to the consultant such as those students the consultant is most interested in providing advice to.

Thus, depending on the value, state or content of the primary, visibility indicators received by the platform 4, information about a consultant 5a, 5b, . . . 5n and 500 may, or may not, be disclosed to an offeree or offeror. There are many variations and levels of disclosure that the consultant may choose. For example, in embodiments of the invention a respective consultant may choose to send one or more primary, visibility indicators to the platform 4, including one or more that indicate: (i) the identity of the respective consultant should be provided to a number of offerees and/or offerors; (ii) the identity of the consultant should not be provided to a number of offerees and/or offerors; (iii) the consultant's advice/message(s) should be provided to a number of offerees and/or offerors; and/or (iv) the advice/message(s) should not be provided to a number of offerees and/or offerors, where, again the “number” of offerees and/or offerors may be 0, 1 or more than 1 (where 1 may be a version of the double blind matching scenario discussed elsewhere herein).

Upon receiving the primary consultant visibility indicators from a respective consultant 5a, 5b, . . . 5n or 500 the platform 4 is operable to process the received indicators and determine whether information about the respective consultant may be disclosed based on the value of the indicators associated with the respective consultant. The indicator values may take the form of many different types of electronic signals known to those in the art it being understood that a different value is associated with a different level of disclosure (e.g., no disclosure, limited disclosure, or wide disclosure of a consultant's identity and/or advice/message(s) to 0, 1 or more than 1 offeree and/or offeror). Upon determining the level of disclosure associated with the received primary, consultant visibility indicators associated with a respective consultant the platform 4 may be operable to complete a plurality of functions, including, but not limited to the following: (i) provide the identity of the respective consultant to a number of offerees and/or offerors; (ii) inhibit the provisioning of the identity of the consultant to the number of offerees and/or offerors; (iii) provide the consultant's advice/message(s) to a number of offerees and/or offerors and/or (iv) inhibit the provisioning of the advice/message(s) to the number of offerees and/or offerors (where, again, 1 may be a version of the double blind matching scenario discussed elsewhere herein).

In addition to providing embodiments that permit a consultant to control how their identity and advice/message(s) will be distributed to offerees and offerors (using primary visibility indicators), the present invention provides for embodiments that permit a consultant to control how their identity and advice/messages will be distributed to other consultants, such as those consultants that may be competing for the same students that are requesting academic, career or resource-related advice (e.g., how to apply for financial aid), for example. In such a scenario a consultant may wish to limit the distribution of their identity, and their associated advice/message(s). Still further, other competitive and confidentiality considerations may concern the consultant and cause the consultant to decide to limit disclosure of their identity, and associated advice/message(s) to other consultants.

Realizing this, the present invention provides embodiments that permit a respective consultant to control how their identity, and advice/message(s) will be distributed to other consultants. In one embodiment, secondary, consultant visibility indicators are used to indicate the level of disclosure of a respective consultant. For example, the platform 4 may be operable to receive one or more secondary, consultant visibility indicators from a number of consultants (i.e., consultant device 5a, 5b, . . . 5n or 500) where the indicators include an indicator that indicates the level of disclosure for each respective consultant's information, and then determine whether to provide the identity of each respective consultant and the consultant's advice/message(s) to a number of other consultants (5a,5b, . . . 5n or 500) based on the level of disclosure indicated by the received secondary, offeror visibility indicators associated with each respective consultant. Similar to the descriptions above, the number of other consultants providing information and the number of “other” consultants authorized to receive the information may be 0, 1 or more than 1 (where, again, 1 may be a version of the double blind matching scenario discussed elsewhere herein).

Upon receiving the secondary, consultant visibility indicators the platform 4 may be operable to process the received indicators and determine whether information about a respective consultant may be disclosed based on the value of a respective consultant's associated indicators. Again, the indicator values may take the form of many different types of electronic signals known to those in the art it being understood that a different value is associated with a different level of disclosure (e.g., no disclosure, limited disclosure, or wide disclosure of a respective consultant's identity, the, and/or advice/message(s) to 0, 1 or more than 1 additional consultant). Upon determining the level of disclosure associated with the received secondary, consultant visibility indicators associated with the respective consultant, the platform 4 may be operable to complete a plurality of functions, including, but not limited to the following: (a) provide the identity of the respective consultant to a number of other consultants; (b) inhibit the provisioning of the identity of the consultant to the number of other consultants; (c) provide the consultant's advice/message(s) to a number of other consultants; and/or (iv) inhibit the provisioning of the advice/message(s) to the number of other consultants (where, again, 1 may be a version of the double blind matching scenario discussed elsewhere herein).

In embodiments of the invention, upon determining that the identity of an offeree, offeror or consultant may be provided to another offeree, offeror and/or consultant the platform 4 may be operable to so provide such identities in step 4001 (see FIG. 4C) as well as provide the credentials of an offeree, offers from an offeror and advice from a consultant, for example. Further, in step 4002 the platform 4 may be operable to communicate with a respective offeree, offeror or consultant (i.e., with their respective devices 20, 30, 50, 200, 300, 500) that has originally provided information to the platform 4 during steps 2400, 3400 in order to provide an indication to such an originating offeree, offeror or consultant that their respective identity, credentials, offers, advice, etc., has been so communicated to other offerees, offerors or consultants. In embodiments of the invention such indications may be provided as data or other information that may be formatted and displayed on an interface, such as interfaces 202, 302 or 502 shown in FIG. 2, or on a dashboard, such as dashboard 60 shown in FIG. 3.

In one embodiment, upon receiving an offer from an offeror an offeree may decide to accept the offer, provide suggested modifications (i.e., a counter-offer) to the offering offeror or reject the offer in step 4003. In response, the offering offeror may decide to respond to any suggested modification to the original offer, provide a confirmation of the accepted offer along with additional information regarding the details of the offer and how the offer is to be fulfilled and implemented (e.g., provide documents to be signed) or provide other responses related to the offeree's declination of the original offer in step 4004. In such circumstances the communications between the offeror and offeree may be provided via the platform 4, or via another platform (not shown in the figures). In the situation where a consultant is involved, upon receiving advice or other communications from a consultant an offeree may decide to accept the advice, provide suggested modifications (i.e., ask additional questions or provide additional information) to the consultant or reject the advice in step 4005. In response, the consultant may decide to respond to any suggested modification to the original advice, provide a confirmation of the accepted advice, or provide other responses related to the offeree's declination of the original advice in step 4006. In such circumstances the communications between the consultant and offeree may be provided via the platform 4, or via another platform (not shown in the figures). Further, the communications between an offeree, offeror and/or consultant may be provided as data or other information formatted for display on an interface, such as interfaces 202, 302 or 502 shown in FIG. 2, or on a dashboard, such as dashboard 60 shown in FIG. 3.

While exemplary embodiments have been shown and described herein, it should be understood that variations of the disclosed embodiments may be made without departing from the spirit of the invention. For example, though the discussion above uses educational or career related offers as examples to explain the invention, it should be understood that the invention is not so limited. Other types of offers and related offerees, offerors and consultants are encompassed by the present invention. In general, the teachings of the present invention (i.e., the specialized computing platform 4) may be used in negotiations, transactions or other human interactions where one or more of the individuals or entities involved in the negotiation, transaction or interaction desires to withhold their identity from another individual or entity involved in the same negotiation, transaction or interaction. However, it should be understood that the present invention provides for physical embodiments that enable information related to a negotiation, transaction or interaction to be processed much faster than humanly possible. That is to say, each of the embodiments of the present invention cannot practically be implemented in any amount of time that would be acceptable to one skilled in the art using human beings as substitutes for the systems, devices, databases and platforms described herein. For example, many of the embodiments described herein involve an exchange of information via a network between a physical user device and network device that are remotely located from one another, where the information exchanged must be available for immediate display to a user involved in the exchange of information. Accordingly, the speeds at which the information is exchanged, and the amount of information exchanged is many times faster than can be communicated and processed by the human mind. Nor can such information be displayed by the human mind or mechanical means (pen and paper) within the time periods demanded by users of the present invention and those skilled in the art of the present invention.

The claims that follow are intended to cover the exemplary embodiments described herein along with any equivalents of such embodiments.

1. A system for providing improved, online educational and career information exchanges comprising:
a network hardware platform operable to,
receive information identifying one or more offers, offeree of the offers, offeree credentials and one or more primary, offeree visibility indicators from a device associated with the offeree; and
determine whether to provide an identity of the offeree and the offeree's credentials to one or more devices, each device associated with an offeror of the one or more offers based on the one or more primary, offeree visibility indicators.

2. (canceled)

3. The system as in claim 1 wherein each offeror device is associated with a member of an academic institution, trade or vocational institution, a trade or vocation, an employer or a resource provider.

4. The system as in claim 1 wherein the one or more primary, offeree visibility indicators include one or more indicators that indicate the offeree's identity and credentials should, or should not, be provided to the number of devices associated with the offerors.

5. The system as in claim 1 wherein the offeree credentials comprise at least an offeree academic record or life experiences record.

6. The system as in claim 1 wherein the one or more primary, visibility indicators include an indicator that indicates the identity of the offeree should be provided to the number of devices associated with the offerors, the network hardware platform further operable to provide the identity of the offeree to the number of devices associated with the offerors.

7. The system as in claim 1 wherein the one or more primary, offeree visibility indicators include an indicator that indicates the identity of the offeree should not be provided to the number of devices associated with the offerors, the network hardware platform further operable to inhibit the provisioning of the identity of the individual to the number of devices associated with the offerors.

8. The system as in claim 1 wherein the one or more primary, visibility indicators include an indicator that indicates the offeree credentials should be provided to the number of devices associated with the offerors, the network hardware platform further operable to provide the credentials to the number of devices associated with the offerors.

9. The system as in claim 1 wherein the one or more primary, visibility indicators include an indicator that indicates the offeree credentials should not be provided to the number of devices associated with the offerors, the network hardware platform further operable to inhibit the provisioning of the credentials to the number of devices associated with the offerors.

10. The system as in claim 1, wherein the platform is further operable to:
receive information regarding the identity of one or more of the offerors, each identified offeror's offer and one or more primary, offeror visibility indicators associated with each of the one or more offerors from the devices associated with the offerors; and
determine whether to provide the identity of each of the one or more offerors and each offeror's offer to the device associated with the offeree based on the one or more primary, offeror visibility indicators.

11. The system as in claim 10 wherein the one or more primary, offeror visibility indicators include one or more indicators that indicate one or more of the offerors' identities should, or should not, be provided to the device associated with the offeree.

12. The system as in claim 10 wherein the one or more primary, offeror visibility indicators include an indicator that indicates the identity of the one or more offerors should be provided to the device associated with the offeree, the network hardware platform further operable to provide the identity of the one or more offerors to the device associated with the offeree.

13. The system as in claim 10 wherein the one or more primary, offeror visibility indicators include an indicator that indicates the identity of the one or more offerors should not be provided to the device associated with the offeree, the network hardware platform further operable to inhibit the provisioning of the identity of the one or more offerors to the device associated with the offeree.

14. The system as in claim 10 wherein the one or more primary, offeror visibility indicators include an indicator that indicates the offers of the one or more offerors that should be provided to the device associated with the offeree, the network hardware platform further operable to provide the indicated offers to the device associated with the offeree.

15. The system as in claim 10 wherein the one or more primary, offeror visibility indicators include an indicator that indicates the offers of the one or more offerors that should not be provided to the device associated with the offeree, the network hardware platform further operable to inhibit the provisioning of the indicated offers to the device associated with the offeree.

16. The system as in claim 10, wherein the platform is further operable to:
receive one or more secondary, offeror visibility indicators associated with each of the one or more offerors from the devices associated with the offerors; and
determine whether to provide the identity of one of the one or more offerors and the offer from such identified offeror to a device associated with another one of the one or more offerors based on the one or more secondary, offeror visibility indicators.

17. The system as in claim 16 wherein the one or more secondary, offeror visibility indicators include one or more indicators that indicates the identity of one of the one or more offerors and the offeror's associated offer that should be provided to a device associated with another one of the one or more offerors.

18. The system as in claim 16 wherein the one or more secondary, offeror visibility indicators include an indicator that indicates the identity of one of the one or more offerors should be provided to a device associated with another one of the one or more offerors, the network hardware platform further operable to provide the identity of the indicated offeror to the device associated with another one of the one or more offerors.

19. The system as in claim 16 wherein the one or more secondary, offeror visibility indicators include an indicator that indicates the identity of one of the one or more offerors, or the offer of one of the one or more offerors, should not be provided to a device associated with another one of the one or more offerors, the network hardware platform further operable to inhibit the provisioning of the identity or offer of the indicated offeror to the device associated with another one of the one or more offerors.

20. The system as in claim 16 wherein the one or more secondary, offeror visibility indicators include an indicator that indicates the offer of one of the one or more offerors should be provided to a device associated with another one of the one or more of offerors, the network hardware platform further operable to provide the indicated offer to the device associated with another one of the one or more of offerors.

21. The system as in claim 16 wherein the one or more secondary, offeror visibility indicators include an indicator that indicates the offer of one of the one or more offerors, and the identity of one of the one or more offerors, should not be provided to a device associated with another one of the one or more offerors, the hardware platform further operable to inhibit the provisioning of the indicated offer and identity to the device associated with another one of the one or more offerors.

22. The system as in claim 1, wherein the platform is further operable to:
receive one or more secondary, offeree visibility indicators from the device associated with the offeree; and
determine whether to provide the identity of the offeree, the offeree's credentials and an offer received by the offeree to one or more devices associated with one or more other offerees based on the one or more secondary, offeree visibility indicators.

23. (canceled)

24. The system as in claim 22 wherein the one or more secondary, offeree visibility indicators include an indicator that indicates the identity of the offeree should be provided to the devices associated with the one or more other offerees, the network hardware platform further operable to provide the identity of the offeree to the devices associated with the number of other offerees.

25. The system as in claim 22 wherein the one or more secondary, offeree visibility indicators include an indicator that indicates the identity of the offeree, or credentials of the offeree, or the offer received by an offeree should not be provided to the devices associated with the one or more other offerees, the network hardware platform further operable to inhibit the provisioning of the identity, credentials or offer received by the offeree to the devices associated with the number of other offerees.

26. The system as in claim 22 wherein the one or more secondary, offeree visibility indicators include an indicator that indicates the credentials of the offeree should be provided to the devices associated with the one or more other offerees, the network hardware platform further operable to provide the offeree's credentials to the devices associated with the number of other offerees.

27. The system as in claim 22 wherein the one or more secondary, offeree visibility indicators include an indicator that indicates the credentials of the offeree, identity of the offeree and the offer received by the offeree should not be provided to the devices associated with the one or more other offerees, the network hardware platform further operable to inhibit the provisioning of the credentials of the offeree, identity of the offeree and an offer received by the offeree to the devices associated with the number of other offerees.

28. The system as in claim 1 further comprising a wired or wireless device associated with the offeree operable to transmit the information identifying the offeree, the offeree's credentials and the one or more primary, offeree visibility indicators to the network hardware platform, or receive an identity of each offeror and each offeror's offer, and advice from a device associate with a consultant.

29. The system as in claim 1 further comprising one or more wired or wireless devices, each associated with an offeror and each operable to receive the identity of the offeree and the offeree's credentials, and transmit information regarding an identity of a user of the offeror user device, an offer and one or more primary and secondary, offeror visibility indicators.

30. The system as in claim 1 further comprising a wired or wireless device associated with the offeree operable to receive an identity of each offeror and each offeror's offer, or advice from a device associated with a consultant.
